(19) United States
(12) Patent Application Publication
(10) Pub. No.: US 2004/0243392 A1
(43) Pub. Date: Dec. 2, 2004

(54) Communication support apparatus, method and program

(75) Inventors: Tetsuro Chino, Kawasaki-shj (JP); Kazuo Sumita, Yokohama-shi (JP); Tatsuya Izuha, Kawasaki-shi (JP); Yuka Morimoto, Yokohama-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/753,480

(22) Filed: Jan. 9, 2004

(30) Foreign Application Priority Data
May 27, 2003 (JP) 2003-149338

(51) Int. Cl. G06F 17/28

(52) U.S. Cl. 704/7

(57) ABSTRACT

A communication support apparatus comprises an acquisition unit configured to acquire source-language information represented in a first language, a first determination unit configured to determine a level of importance of the source-language information, a setting unit configured to set, based on the level of importance, an accuracy of translation with which the source-language information is translated into corresponding language information represented in a second language, and a translation unit configured to translate the source-language information into the corresponding language information with the accuracy.

### CROSS-REFERENCE TO RELATED APPLICATIONS

This application is based upon and claims the benefit of priority from the prior Japanese Patent Application No. 2003-149338, filed May 27, 2003, the entire contents of which are incorporated herein by reference.

### BACKGROUND OF THE INVENTION

1. Field of the Invention

The present invention relates to a communication support apparatus, method and program for translation between two or more languages of exchanged messages for communication.

2. Description of the Related Art

Recently, interlingual and cross-cultural exchanges have become prevalent, therefore there is an increasing need for smooth communications (hereinafter referred to as “interlingual communications”) between the people speaking different languages as mother tongues.

To master the (foreign) language(s) of the people to communicate with is very difficult and requires a lot of time, effort and money. To perform interlingual communication, an interpreter who is familiar with a foreign language needed for the communication could be employed. However, the number of interpreters is limited and they are costly. Therefore, interpreters are not widely utilized. Further, when, for example, a person travels oversees, they could use a phrase book in which phrases needed in various scenes are recited in relation to their interpretations. In this case, however, the number of phrases contained in the book is limited and not sufficient in actual conversation scenes. Further, it takes a lot of time and effort for a person to keep in mind speech formulas recited in the book. Also, it is difficult to quickly find, in an actual conversation scene, the page on which the needed phrase is recited. Thus, a phrase book is not a very practical means for actual conversation.

Portable electronic translation machines that store electronic data corresponding to such phrases as the above could be utilized. A user holds a translation machine, for example, in one hand, and designates a to-be-translated sentence or searches for a needed expression by operating a keyboard and/or selecting a menu. The translation machine converts an input sentence into another language, and displays the resultant translation on a display or outputs it in the form of voice data (see, for example, Jpn. Pat. Appln. KOKAI Publication No. 8-328585). However, the translation machines perform translations also on the basis of limited speech formulas, and cannot realize sufficient communication between people using different languages. Further, if the number of phrases and expressions contained in the translation machines is increased, it is difficult for users to select a to-be-translated sentence, which reduces the usefulness in actual communication.

Moreover, improvements in, for example, voice recognition technology, handwriting-recognition technology, natural language processing techniques, and especially, fast and accurate machine translations have come about. Realization of an apparatus that supports interlingual communications utilizing such techniques is now increasingly demanded. In particular, in face-face communication, the best way to translate a message is to input and output it in the form of voice. In light of this, Jpn. Pat. Appln. KOKAI Publication No. 2-7168, for example, discloses a combination of voice recognition and voice synthesis, in which a message input in the form of voice data is recognized and analyzed, then translated into a message of another language, and output in the form of voice data.

Furthermore, thanks to developments in communications, e.g. the Internet, radio networks, etc., a communication support service has come to be possible in which voice recognition, language analysis, translation, language generation, voice synthesis, etc. are handled by equipment installed in a communication center, thereby realizing a server/client application service for enabling clients to use the communication support service through a device connected to the center via a network.

However, many voice messages spoken in a foreign language (i.e., non-mother tongue) are not included in grammatically ill-formed spontaneous expression, therefore are not translatable. This means that support apparatuses are useless in many cases. Furthermore, if a support apparatus cannot even perform voice recognition, a message spoken in a foreign language cannot even be confirmed. In particular, for public-address announcements e.g. in transportation facilities, it is not expected that the message be displayed using characters or pictures. Moreover, such announcements usually report emergent matter. Therefore, whether or not recognition and translation of a voice message has succeeded may become a life-and-death situation for users.

In addition, realization of a support apparatus of high performance may require expensive components, a complicated internal structure, large scale or high power consumption. In other words, it is difficult to realize high performance together with any of downsizing, weight saving, cost down and lower power consumption.

Further, communication services cannot be used in places such as airplanes, hospitals, etc., therefore support apparatuses cannot access the communication center via a network to utilize voice recognition or translation. Further, a time delay may well occur in processing via communication, requiring much time for translation, which substantially reduces the functionality of support apparatuses. In addition, radio communication incurs heavy power consumption. However, portable support apparatuses use batteries, therefore cannot operate for a long time. Thus, support apparatuses cannot always be used even if they are connected to a communication center via a radio network.

### BRIEF SUMMARY OF THE INVENTION

The present invention has been developed in light of the above, and aims to provide a communication support apparatus that shows an excellent response from input to output, and provides excellent translations, and also a communication support method and program for realizing the functions of the apparatus.

According to a first aspect of the invention, there is provided a communication support apparatus comprising: an acquisition unit configured to acquire source-language information represented in a first language; a first determination unit configured to determine a level of importance of the source-language information; a setting unit configured to set, based on the level of importance, an accuracy of translation with which the source-language information is translated into corresponding language information represented in a second language; and a translation unit configured to translate the source-language information into the corresponding language information with the accuracy.

According to a second aspect of the invention, there is provided a communication support apparatus comprising: an acquisition unit configured to acquire source-language information represented in a first language; a first determination unit configured to determine a level of importance of the source-language information; a translation unit configured to translate the source-language information into corresponding language information represented in a second language; an exhibit unit configured to exhibit the corresponding language information; a setting unit configured to set, based on the level of importance, a process accuracy with which at least one of an acquisition process to be carried out by the acquisition unit, a translation process to be carried out by the translation unit, and an exhibit process to be carried out by the exhibit unit is performed; and an execution unit configured to execute at least one of the acquisition process, the translation process and the exhibit process with the process accuracy.

According to a third aspect of the invention, there is provided a communication support method comprising: acquiring source-language information represented in a first language; determining a level of importance of the source-language information; translating the source-language information into corresponding language information represented in a second language; exhibiting the corresponding language information; setting, based on the level of importance, a process accuracy with which at least one of an acquisition process for acquiring the source-language information, a translation process for translating the source-language information into the corresponding language information, and an exhibit process for exhibiting the corresponding language information is performed; and executing at least one of the acquisition process, the translation process and the exhibit process with the process accuracy.

According to a fourth aspect of the invention, there is provided a communication support program stored in a computer readable medium, comprising: means for instructing a computer to acquire source-language information represented in a first language; means for instructing the computer to determine a level of importance of the source-language information; means for instructing the computer to translate the source-language information into corresponding language information represented in a second language; means for instructing the computer to exhibit the corresponding language information; means for instructing the computer to set, based on the level of importance, a process accuracy with which at least one of an acquisition process to be carried out by the means for instructing the computer to determine the level, a translation process to be carried out by the means for instructing the computer to translate the source-language information, and an exhibit process to be carried out by the means for instructing the computer to exhibit the corresponding language information is performed; and means for instructing the computer to execute at least one of the acquisition process, the translation process and the exhibit process with the process accuracy.

### BRIEF DESCRIPTION OF THE SEVERAL VIEWS OF THE DRAWING

FIG. 1 is a block diagram illustrating a communication support apparatus according to a first embodiment of the invention;

FIG. 2 is a block diagram illustrating the importance determination unit appearing in FIG. 1;

FIG. 3 shows a specific example of an important keyword table stored in the important keyword storage appearing in FIG. 2;

FIG. 4 shows an example of a first-language internal expression;

FIG. 5 is a flowchart useful in explaining the process performed by the communication support apparatus of FIG. 1;

FIG. 6 shows examples of results obtained by the process shown in FIG. 5;

FIG. 7 is a block diagram illustrating another example of the importance determination unit in FIG. 1;

FIG. 8 is a table a similar-keyword table stored in the keyword storage appearing in FIG. 7;

FIG. 9 is a flowchart useful in explaining the process performed by the communication support apparatus of FIG. 1 equipped with the importance determination unit appearing in FIG. 7;

FIG. 10 is a flowchart useful in explaining a modification of the process illustrated in FIG. 9;

FIG. 11 is a block diagram illustrating a communication support apparatus according to a second embodiment of the invention;

FIG. 12 is a flowchart useful in explaining the process performed by the communication support apparatus of FIG. 11;

FIG. 13 illustrates examples of results obtained by the process shown in FIG. 12;

FIG. 14 is a block diagram illustrating a communication support apparatus according to a third embodiment of the invention;

FIG. 15A is a flowchart useful in explaining the process performed by the rhythm analysis unit appearing in FIG. 14;

FIG. 15B is a flowchart useful in explaining the process performed by the living body sensor appearing in FIG. 14;

FIG. 16 illustrates examples of results obtained by the processes shown in FIGS. 15A and 15B;

FIG. 17 is a block diagram illustrating a communication support apparatus according to a fourth embodiment, and a server apparatus;

FIG. 18 is a flowchart useful in explaining the process performed by a communication support system including the communication support apparatus of FIG. 17;

FIG. 19 illustrates examples of results obtained by the process shown in FIG. 18; and

FIG. 20 is a block diagram illustrating a modification of the server apparatus appearing in FIG. 17.

### DETAILED DESCRIPTION OF THE INVENTION

Communication support apparatuses, methods and programs according to embodiments of the invention will be described in detail with reference to the accompanying drawings.

In the description, English is assumed as a first language, and Japanese is assumed as a second language. Further, it is also assumed that the users of the communication support apparatuses of the embodiments are people whose mother tongue is Japanese, and use the apparatuses, methods and programs of the embodiments when they travel in English-speaking countries. However, the combination of languages, the mother tongue or liguistic ability of each user, the place at which the communication support apparatuses of the embodiments are used are not limited to those mentioned below.

(First Embodiment)

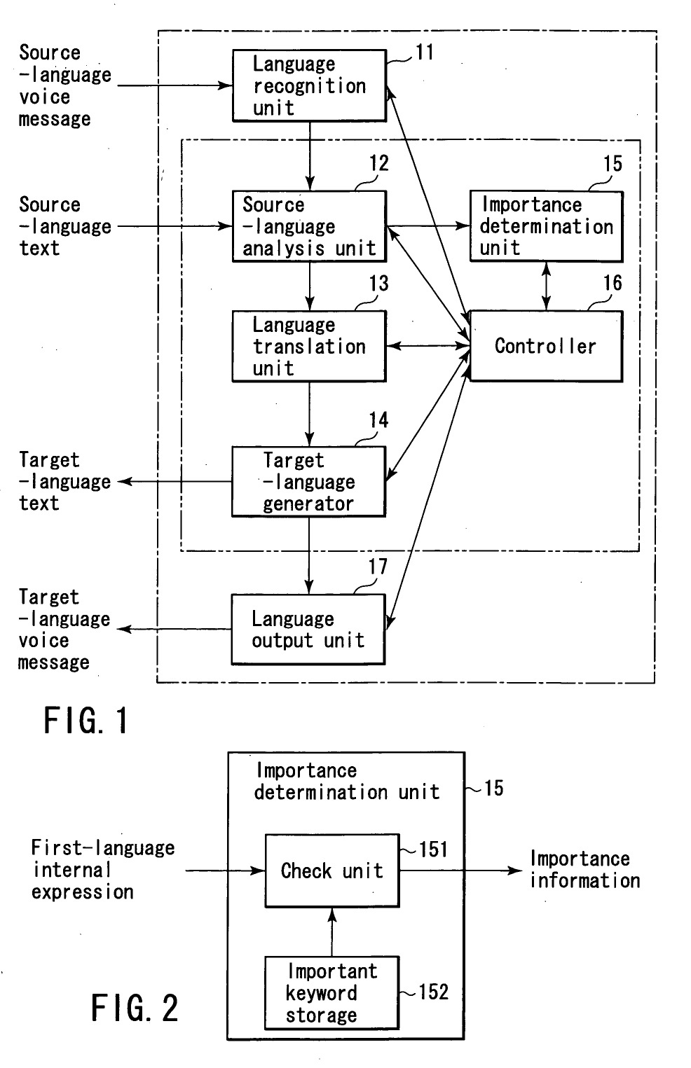

FIG. 1 is a block diagram illustrating a communication support apparatus according to a first embodiment of the invention.

A language recognition unit 11 recognizes an input voice message spoken in the first language, utilizing a voice recognition technique. The language recognition unit 11 converts the recognized voice message into a character string (hereinafter referred to as a “source-language surface character string) as a source-language text, and outputs the character string to a source-language analysis unit 12. The process of converting a recognized voice message into a source-language surface character string is called a “voice dictation recognition process”, and can be realized by a conventional technique.

The language recognition unit 11 may receive and recognize a voice message spoken in the second language. In all the embodiments described below, each unit may perform “first language” to “second language”, and vice versa, processing. This process is performed to deliver a message spoken in the second language to a person whose mother tongue is the first language.

In the embodiment, the language recognition unit 11 processes only voice messages, but may be modified such that it incorporates, for example, a camera unit and character recognition unit, thereby recognizing an input image of characters of the first language and outputting the recognition result as an internal expression to the source-language analysis unit 12.

The source-language analysis unit 12 receives a source-language surface character string of the first language, and performs, for example, morpheme analysis, syntax analysis, meaning analysis of the character string. As a result, the source-language analysis unit 12 generates an internal expression in the form of a syntax analysis tree, a meaning network, etc., which is based on the first language and corresponds to a source-language input (hereinafter, an internal expression based on the first language will be referred to as a “first-language internal expression). A specific example of this will be described later with reference to FIG. 4. The source-language analysis unit 12 outputs the generated internal expression to a language translation unit 13. If the message input to the communication support apparatus is not a voice message spoken in the first language, but a text message written in the first language, the input message is directly supplied to the language analysis unit 12, without being passed through the language recognition unit 11.

The language translation unit 13 translates the input first-language internal expression into the second language. Thus, the language translation unit 13 performs translation of words from the first language to the second language, translation of a syntactic structure of the first language into a syntactic structure of the second language. As a result, the language translation unit 13 converts the first-language internal expression into an internal expression in the form of a syntax analysis tree, a meaning network, etc., which is based on the second language and corresponds to the source-language input (hereinafter an internal expression based on the second language will be referred to as a “second-language internal expression).

The language translation unit 13 performs translation under the control of a controller 16, by appropriately changing the parameters for controlling processing accuracy and load that is in a trade-off relationship. For example, the number of candidate structures to be analyzed in syntax analysis is one of the parameters. Another parameter is the distance between the to-be-analyzed words or morphemes contained in an input sentence that are in a modification relation. Yet another parameter is the number of the meanings of each to-be-analyzed polysemous word, or the frequency of appearance of a to-be-analyzed meaning or co-occurrence information, in the syntax or meaning analysis of an input sentence. Co-occurrence information means natural connection of words. For example, it indicates that “weather” is not used together with “allowing” but may be used together with “permitting”. According to the co-occurrence information, “Meals will be served outside, weather allowing” should be changed to “Meals will be served outside, weather permitting”.

The language translation unit 13 changes the parameters in accordance with an instruction from the controller 16, thereby selecting one of the translation modes. The translation modes include, for example, a low-load high-speed mode in which the translation speed takes priority, and a high-load high-accuracy mode in which the translation accuracy takes priority. In the low-load high-speed mode, the load on the language translation unit 13 is set low, and quick acquisition of translations of disregarding accuracy is attempted. In the high-load high-accuracy mode, the load on the language translation unit 13 is set high, and acquisition of translations of high accuracy is attempted. Thus, the low-load high-speed mode quickly provides translations but does not provide a high translation accuracy. On the other hand, the high-load high-accuracy mode provides a high translation accuracy, but requires a lot of time to complete a translation. Naturally, modes other than the above can be set.

In different translation modes, the number of candidates, from which an expression of the second language corresponding to an expression of the first language is selected, differs, and the range in a dictionary, in which candidates are searched for, differs. Both the number of such candidates and the range are larger in the high-load high-accuracy mode than in the low-load high-speed mode.

A target-language generator 14 receives a second-language internal expression and performs a language generation process on the second-language internal expression, thereby generating a corresponding surface character string of the second language. The target-language generator 14 can output the corresponding surface character string as a target-language text. The language generation process includes, for example, the control of the order of structural elements, conjugation of words, and selection of words.

A series of processes performed by the source-language analysis unit 12, language translation unit 13 and target-language generator 14 is an application of the natural language processing technique employed in the translation apparatus described in, for example, Japanese Patent No. 3131432.

An importance determination unit 15 receives a first-language internal expression, and obtains, by computation, determination data for determining whether or not language information corresponding to the first-language internal expression is important, and outputs the obtained determination data to the controller 16. The language information is, for example, voice data input to the language recognition unit 11, or a source-language text input to the source-language analysis unit 12.

The controller 16 controls the language recognition unit 11, source-language analysis unit 12, language translation unit 13, target-language generator 14, importance determination unit 15 and language output unit 17. In particular, the controller 16 outputs a control signal to each unit on the basis of the determination data obtained by the importance determination unit 15. For example, the controller 16 supplies the language translation unit 13 with a control signal for designating the translation mode of the language translation unit 13. Further, the support apparatus may be constructed such that a high-accuracy mode and standard mode are set for each unit, and the controller 16 instructs each unit to select an appropriate one of the modes. Naturally, three or more modes may be set for some units, or no mode may be set for some units.

Further, the controller 16 may instruct each unit to re-execute a certain process if the result of the process in each unit is insufficient. The controller 16 may also control the number of occasions of the re-execution. The criterion of a determination as to whether or not the output result of each unit is sufficient differs between the units, depending upon the contents of the process. Accordingly, a threshold value for determining whether or not the output result is sufficient may be set in each unit. In this case, the controller 16 compares the output result of each unit with the threshold value, thereby determining whether or not the output result is sufficient.

When supplying each unit with an instruction to execute its process, the controller 16 may also control the memory capacity permitted for the process, the process time and process speed.

A language output unit 17 receives a corresponding surface character string of the second language, thereby synthesizing second-language voice data corresponding to the surface character string, and outputting it to, for example, a speaker. Thus, a text-to-speech synthesis process is performed. Since the text-to-speech synthesis process can be performed by a known technique, no further description is given thereof.

Both the language recognition unit 11 and language output unit 17 are not indispensable elements but arbitrary ones.

FIG. 2 is a block diagram illustrating the importance determination unit 15 appearing in FIG. 1.

The importance determination unit 15 comprises a check unit 151 and an important keyword storage 152. The check unit 151 refers to the contents of the important keyword storage 152 described later, and determines whether or not the structural elements of a first-language internal expression output from the source-language analysis unit 12 include an important keyword. The important keyword means, for example, a keyword that indicates an emergent matter. The check unit 151 determines the level of importance of the first-language internal expression output from the source-language analysis unit 12, on the basis of a score corresponding to each important keyword stored in the important keyword storage 152. The check unit 151 supplies the controller 16 with importance information indicative of the importance level. The importance level is obtained by, for example, summing up the scores corresponding to all important keywords extracted from a first-language internal expression output from the source-language analysis unit 12.

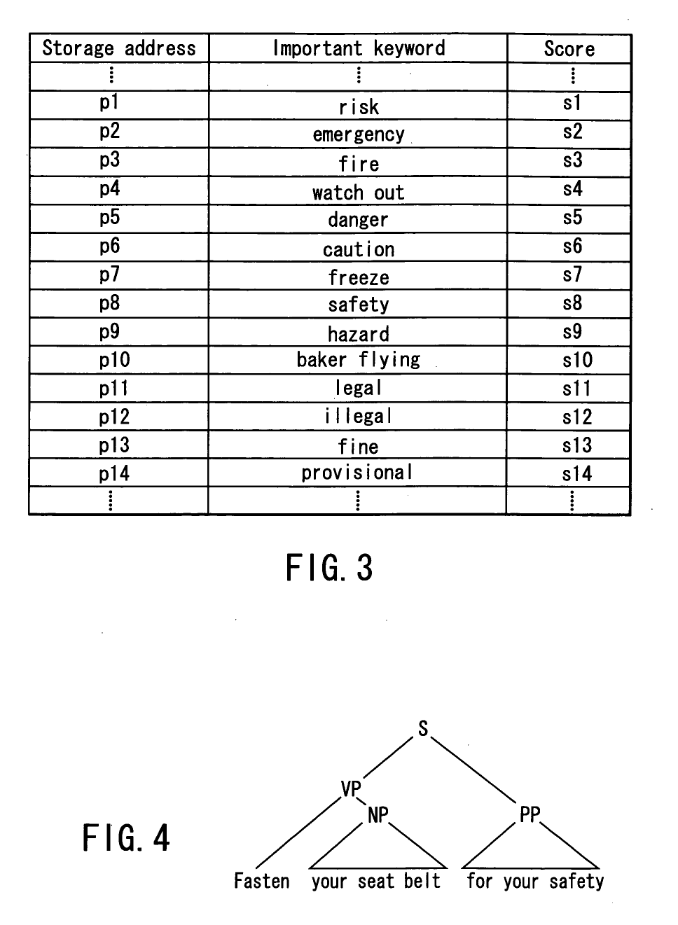

The important keyword storage 152 usually stores a plurality of important keywords, and scores corresponding to the important keywords. The important keyword storage 152 further stores addresses (storage address in FIG. 3) assigned to the respective areas that store the important keywords and their scores. For facilitating the explanation, it is assumed in the embodiment that the storage addresses, important keywords and scores are stored in the form of a table as shown in FIG. 3. Of course, it is sufficient if the storage addresses, important keywords and scores are stored in relation to each other, and it is not always necessary to arrange them in a table.

FIG. 3 illustrates a specific example of the important keyword table stored in the important keyword storage 152 of FIG. 2.

As shown in FIG. 3, the important keyword storage 152 prestores each storage address, important keyword and score in relation to each other. Specifically, in the entry with a storage address p1, the important keyword is “risk” and the score is “s1” (numerical value). This means that the important keyword “risk” and its score “s1” are stored in the area with the storage address p1. Further, the important keyword table indicates that the score indicative of the level of importance of a sentence containing the important keyword “risk” is s1. The same can be said of any other storage address entry.

FIG. 4 shows a specific example of a first-language internal expression.

A first-language internal expression, output from the source-language analysis unit 12 to the check unit 151, has, for example, a syntactic structure tree resulting from a syntax analysis. FIG. 4 shows a syntactic structure tree resulting from a syntax analysis performed on the sentence “Fasten your seat belt for your safety” input to the communication support apparatus. In FIG. 4, “S” is an abbreviation of “sentence”, “VP” an abbreviation of “verb phrase”, “PP” an abbreviation of “prepositional phrase”, and “NP” an abbreviation of “noun phrase”. In this example, “PP” and “NP” are expressed in the form of a triangle obtained by omitting part of the syntactic structure tree.

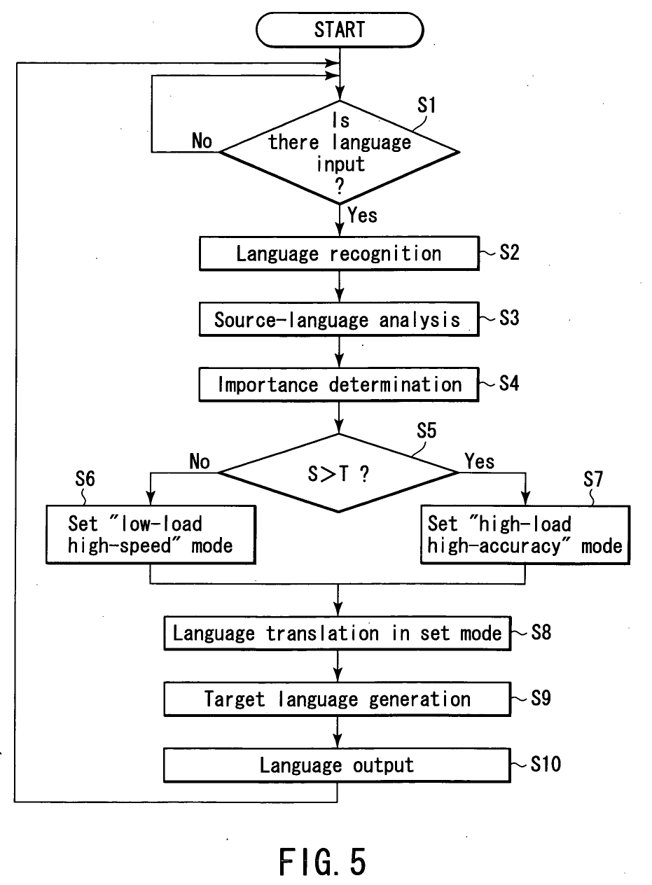

FIG. 5 is a flowchart useful in explaining the process performed by the communication support apparatus of FIG. 1. Each step of the flowchart is executed by a corresponding unit of FIG. 1 when the controller 16 outputs an instruction to the unit.

It is determined whether or not voice data is input to the language recognition unit 11 (step S1). If it is determined that voice data is input to the language recognition unit 11, the program proceeds to a step S2. On the other hand, if it is determined that no voice data is input there, the step S1 is repeated at a regular period.

At the step S2, the language recognition unit 11 is instructed to convert the input voice data into a source-language surface character string. The source-language surface character string is input to the source-language analysis unit 12, where it is analyzed and a first-language internal expression is generated (step S3).

The importance determination unit 15 is instructed to determine whether or not the first-language internal expression generated at the step S3 contains an important keyword stored in the important keyword storage 152 (step S4). In other words, the importance determination unit 15 performs a pattern match verification between the structural elements of the first-language internal expression and the important keywords stored in the important keyword storage 152. As a result of the pattern match verification, the total sum (hereinafter referred to as an “importance determination score”) S of the scores of the important keywords contained in the first-language internal expression is given by the following equation (1) (step S4):

$$S = {\sum }_{i} {sc}_{i} \qquad ( 1 )$$

where scᵢ represents the score of each important keyword shown in FIG. 3. If, for example, the important keyword is “risk”, scᵢ is s1. Further, in the equation (1), i is related to the number of important keywords contained in a first-language internal expression. For example, if the number of important keywords contained in a first-language internal expression is two, i represents 1 and 2, therefore S=sc₁+sc₂.

At the next step S5, it is determined whether or not the importance determination score S computed at the step S4 is higher than a predetermined threshold value T. If it is determined that the importance determination score S is higher than the predetermined threshold value T, the program proceeds a step S7, whereas if it is determined that the importance determination score S is not higher than the predetermined threshold value T, the program proceeds a step S6.

At the step S7, the language translation unit 13 is instructed to set the parameters for controlling the process accuracy and load, to values that can realize a high-load and high-accuracy process. On the other hand, at the step S6, the language translation unit 13 is instructed to set the parameters to values that can realize a low-load and high-speed process. Thus, depending upon whether or not the importance determination score S is higher than the predetermined threshold value T, the translation mode is changed to set the process accuracy and load of the language translation unit 13. The threshold value T is pre-adjusted so that the importance determination score S appropriately corresponds to a to-be-set translation mode.

Subsequently, the language translation unit 13 is instructed to perform a translation from the first language to the second language in accordance with the translation mode set at the step S6 or S7 (step S8). In other words, the language translation unit 13 is instructed to convert the first-language internal expression into a second-language internal expression.

The target-language generator 14 is instructed to receive the second-language internal expression, and performs a language generation process on the second-language internal expression, thereby generating a corresponding surface character string of the second language (step S9).

The language output unit 17 is instructed to receive the corresponding surface character string of the second language, synthesizes voice data corresponding to the surface character string of the second language, and outputs it to, for example, a speaker, followed by the program returning to the step S1 (step S10).

As a result of the control illustrated in FIG. 5, the communication support apparatus can translate important information with a high accuracy, and non-important information at a high speed.

If the input message is a written message, such as a text, the program skips over the step 2 to the step S3, after the step S1. Similarly, if the output message may be a text, the step S10 is omitted.

Further, at the step S1, the language recognition unit 11 may recognize, as well as a voice message, a message written in a character string, acquired by, for example, a camera, thereby converting the character string into a source-language surface character string.

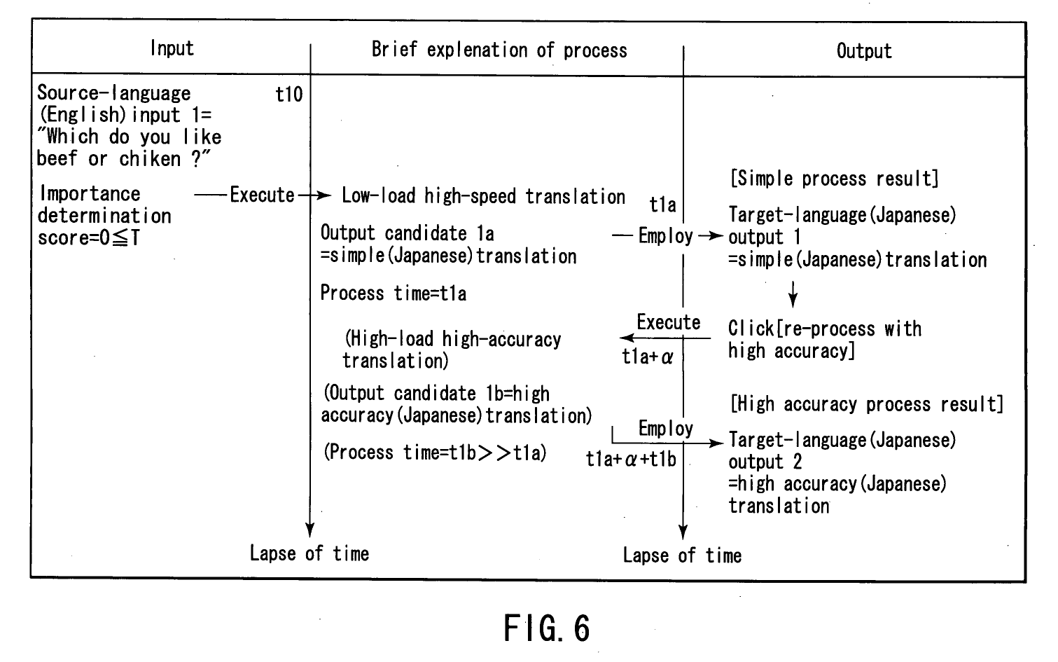

FIG. 6 shows a result example of the process shown in FIG. 5. In this example, a user whose mother tongue is Japanese utilizes the communication support apparatus of FIG. 1 in an English-speaking country.

Assume that when an English-speaker asked the user of the communication support apparatus, “Which do you like, beef or chicken?” (source-language (English) input 1), the apparatus detected this voice message and performed English voice recognition, language analysis and importance determination. Since this sentence does not contain an important keyword, the importance determination score is 0. Accordingly, the importance determination score is lower than the predetermined threshold value T, which means that a translation should be performed in the low-load high-speed mode. As a result, an output candidate 1a (this is a sentence in Japanese corresponding to the above-mentioned English input 1) is obtained as a translation result at a time point t1a, and is provided for a user as a target-language (Japanese) output 1 [as a simple process result].

If the user is not satisfied with the simple process result and wants a more accurate translation, they can click a “re-process with higher accuracy translation” button. The “re-process with higher accuracy translation” button is used to set the translation mode to the high-load high-accuracy mode, thereby enabling an input sentence to be translated with high accuracy. When the “re-process with higher accuracy translation” button is pushed at a time point (t1a+α), translation of an input sentence at the high-load high-accuracy mode is started, and an output candidate 1b (Japanese) corresponding to, for example, an English sentence, “Which would you like to have, a beef menu or chicken menu?”, is obtained as a higher-quality translation result at a time point (t1a+α+tb1b). Thus, the higher-quality translation requires a time period (t1b) that is much longer than a time period (t1a) required for the low-load high-speed mode translation. In other words, the user must wait much longer in the high-load high-accuracy mode than in the low-load high-speed mode.

The “re-process with higher accuracy translation” button is provided on the display panel of the communication support apparatus. This button may be realized by a pressure-sensitive touch button. In this structure, the “re-process with higher accuracy translation” button is displayed on the display panel only after a translation has been performed in the low-load high-speed mode. Therefore, it is not necessary to provide the housing of the communication support apparatus with a “re-process with higher accuracy translation” button dedicated to a re-process with higher accuracy translation.

As described above, in the embodiment, a low-load translation is automatically selected for an input sentence that contains no important words, which realizes a highly responsive communication support apparatus that does not require much time to produce a translation result. Further, if users are not satisfied with a translation result obtained in the low-load translation mode, they can select a translation mode that enables a high accuracy translation.

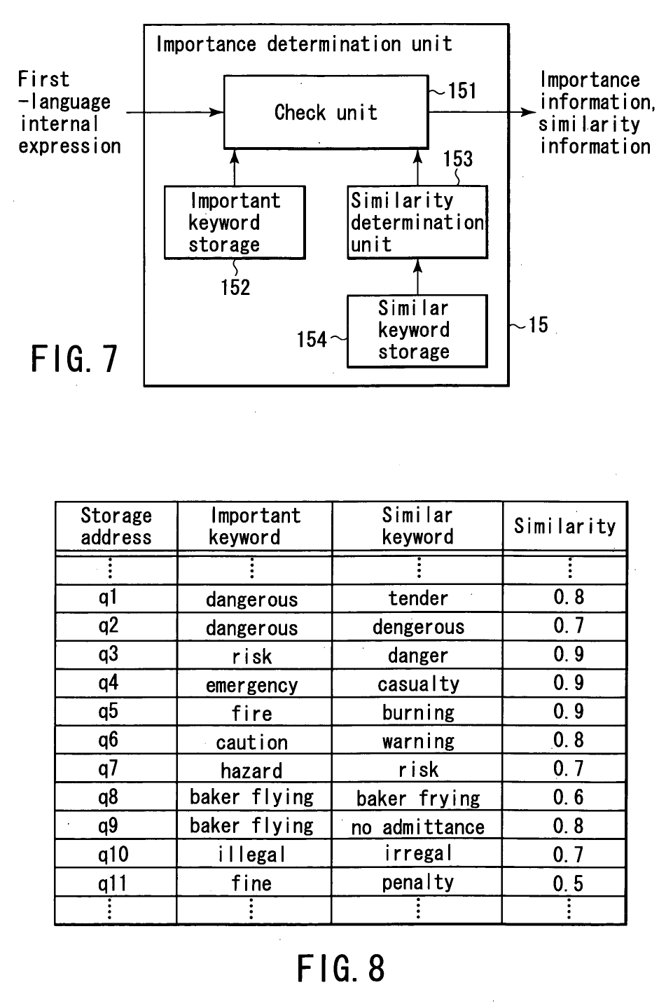

FIG. 7 is a block diagram illustrating another example of the importance determination unit 15 in FIG. 1. The important keyword storage 152 incorporated in this example is similar to that shown in FIG. 2.

The importance determination unit of FIG. 7 comprises a similarity determination unit 153 and similar keyword storage 154, as well as the elements of the importance determination unit of FIG. 2. The similarity determination unit 153 refers to the contents of the similar keyword storage 154, described later, thereby determining whether or not a similar keyword is contained in the structural elements of a first-language internal expression output from the source-language analysis unit 12. If the similarity determination unit 153 determines that a similar keyword is contained, it extracts, from the similar keyword storage 154, the similarity between the similar keyword and a corresponding important keyword. “Similar keyword” means a keyword that is considered to be similar to an important keyword stored in the important keyword storage 152.

The check unit 151 stores each similar keyword, together with the corresponding important keyword and the similarity therebetween extracted by the similarity determination unit 153. The check unit 151 refers to the important keyword storage 152, and determines the level of importance of the first-language internal expression output from the source-language analysis unit 12, based on the score of the important keyword and the similarity between the important keywords and the similar keywords. The check unit 151 thus determines the final level of importance of the first-language internal expression output from the source-language analysis unit 12. Thus, the final level of importance is computed on the basis of the important keywords and the similar keywords contained in the first-language internal expression output from the source-language analysis unit 12.

The final level of importance is computed, for example, in the following manner. All important keywords and similar keywords are extracted from the first-language internal expression output from the source-language analysis unit 12, and the scores corresponding to the extracted important keywords are summed up. Further, the similarity corresponding to each similar keyword in the first-language internal expression is multiplied by the score of the important keyword corresponding to the similar keyword, and all the resultant products are summed up. The resultant sum is considered the final importance level. As another example, the total sum obtained by adding the sum of the scores corresponding to the important keywords to the above-mentioned products concerning all the similar keywords may be used as the final level of importance.

The similar keyword storage 154 usually stores a plurality of similar keywords, and also stores a similarity corresponding to each similar keyword, and an importance keyword corresponding to each similar keyword. The similar keyword storage 154 further stores an address assigned to the area that stores the important keyword and similarity corresponding each similar keyword (storage address in FIG. 8). In the embodiment, for facilitating the description, it is assumed that the storage addresses, important keywords, similar keywords and similarities are stored in the form of a table as shown in FIG. 8. Of course, it is sufficient if the storage addresses, important keywords, similar keywords and similarities are stored in relation to each other, and it is not always necessary to arrange them in a table.

FIG. 8 illustrates a similar keyword table stored in the similar keyword storage 154 of FIG. 7.

As shown in FIG. 8, the similar keyword storage 154 prestores each storage address, important keyword, similar keyword and similarity in relation to each other. Specifically, in the entry with a storage address q1, the important keyword is “dangerous”, the similar keyword is “tender”, and the similarity is “0.8”. This means that the area with the storage address q1 stores the important keyword “dangerous”, the similar keyword “tender” that is considered to be similar to the important keyword, and the similarity of “0.8”. Further, the important keyword table indicates, for example, that the point to be referred to for estimating the importance of a sentence that contains a single similar keyword “tender” is 0.8. The same can be said of any other storage address entry.

The similar keyword table is used to judge that an input sentence containing not only an important keyword, which has an important meaning, but also a word somewhat similar to the important keyword may be very important. A similar word means the one similar to an important keyword in spelling, pronunciation, etc. The use of the similar keyword table can reduce the errors that occur when data is input, analyzed or recognized, thereby enabling a more reliable importance determination.

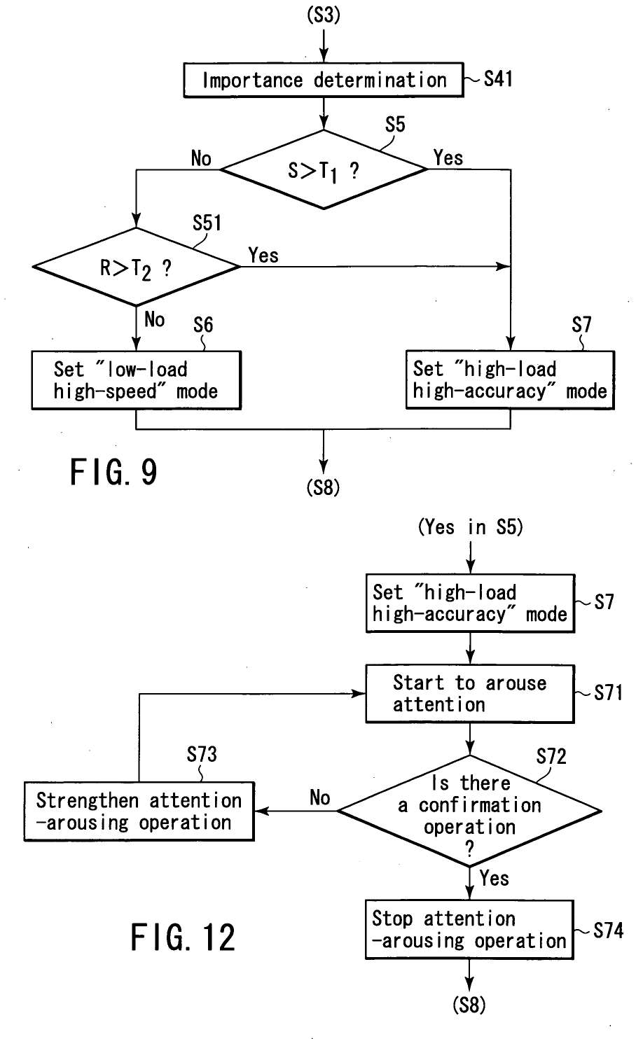

FIG. 9 is a flowchart useful in explaining the process performed by the communication support apparatus of FIG. 1 equipped with the importance determination unit appearing in FIG. 7. The steps S1-S3 and the steps S6 and S7 et seq. are similar to those in the flowchart of FIG. 5. Each step of the flowchart of FIG. 9 is performed when the controller 16 outputs an instruction to a corresponding unit in FIG. 1.

The importance determination unit 15 is instructed to determine whether or not the first-language internal expression generated at the step S3 contains an important keyword stored in the important keyword storage 152 and a similar keyword stored in the similar keyword storage 154 (step S41). In other words, the importance determination unit 15 performs a pattern match verification between the structural elements of the first-language internal expression, the important keywords stored in the important keyword storage 152 and the similar keywords stored in the similar keyword storage 154. As a result of the pattern match verification, the total sum (importance determination score) S of the scores of the important keywords contained in the first-language internal expression is computed using the above-described equation (1). Further, R (hereinafter referred to as a “similarity determination score”) is given by the following equation (2), which is obtained by summing up the products obtained concerning all the similar keywords in the structural elements of the first-language internal expression (step S41):

$$R = {\sum }_{j} {sc}_{j} \times {r}_{j} \qquad ( 2 )$$

where rᵢ represents the similarity of each similar keyword shown in FIG. 8. If, for example, the similar keyword is “tender”, rᵢ is 0.8. Further, in the equation (2), j is related to the number of similar keywords contained in a first-language internal expression. For example, if the number of similar keywords contained in a first-language internal expression is four, j represents 1, 2, 3 and 4, therefore R=sc₁×r₁+sc₂×r₂+sc₃×r₃+sc₄×r₄.

At a step S5, it is determined whether or not the importance determination score S computed at the step S41 is higher than a predetermined threshold value T₁. If it is determined that the importance determination score S is higher than the predetermined threshold value T₁, the program proceeds to a step S7. If, on the other hand, it is determined that the importance determination score S is not higher than the predetermined threshold value T₁, the program proceeds to a step S51. The threshold value T₁ is pre-adjusted so that the importance determination score S will appropriately correspond to the set translation mode.

At the step S51, it is determined whether or not the similarity determination score R computed at the step S41 is higher than a predetermined threshold value T₂. If it is determined that the similarity determination score R is higher than the predetermined threshold value T₂, the program proceeds to the step S7. If, on the other hand, it is determined that the similarity determination score R is not higher than the predetermined threshold value T₂, the program proceeds to a step S6. The threshold value T₂ is pre-adjusted so that the similarity determination score R will appropriately correspond to the set translation mode.

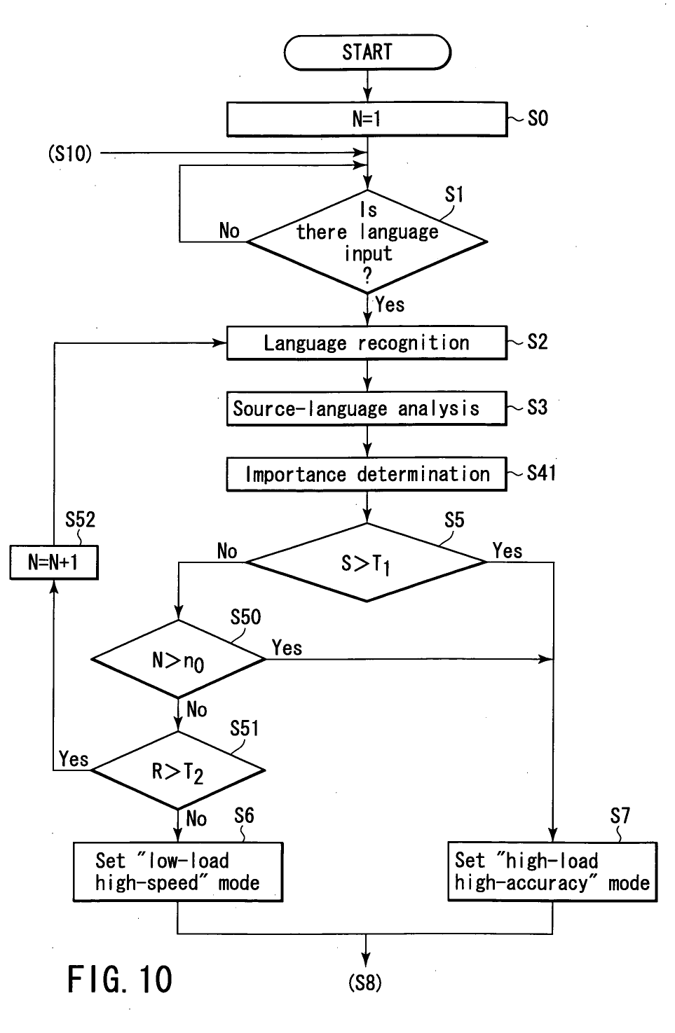

FIG. 10 is a flowchart useful in explaining a modification of the process illustrated in FIG. 9. In the modification of FIG. 10, steps similar to those in FIGS. 5 and 9 are denoted by corresponding reference numerals, and no detailed description is given thereof. Each step of the flowchart of FIG. 10 is performed when the controller 16 outputs an instruction to a corresponding unit in FIG. 1.

The controller 16 resets the counter and sets the counter value N to, for example, 1 (step S0).

If it is determined at the step S5 that the importance determination score S is higher than the predetermined threshold value T₁, the program proceeds to the step S7. If, on the other hand, it is determined that the importance determination score S is not higher than the predetermined threshold value T₁, the program proceeds to a step S50, where it is determined whether or not the counter value N is higher than a preset value n0. If the counter value N is higher than a preset value n0, the program proceeds to the step S7, whereas if the counter value N is not higher than a preset value n0, the program proceeds to the step 51.

If it is determined at the step S51 that the similarity determination score R is higher than the predetermined threshold value T₂, the program proceeds to a step S52. If, on the other hand, it is determined that the similarity determination score R is not higher than the predetermined threshold value T₂, the program proceeds to the step S6.

At the step S52, 1 is added to the counter value N, and the program returns to the step S2. In other words, if the level of importance is determined to be low at the step S5, the counter value N is determined not to be higher than the value n0, and the similarity is determined to be high at the step S51, the language recognition (step S2), source-language analysis (step S3) and importance determination (step S41) are again performed. It is preferable that control be performed so that the accuracy of each process at the steps S2, S3 and S41 will increase as the counter value N increases.

That the counter value N is higher than n0 indicates the case where the similarity determination score R is determined at the step S51 to be higher than the predetermined value T₂ even after language recognition, source-language analysis and importance determination are repeated a number n0 of times. Accordingly, the input sentence is considered important, and the program proceeds to the step S7 (step S50).

In the embodiment, one-way translation from the first language to the second language has been described as an example. However, each process unit may be set so that bi-directional translation can be performed between the first and second languages. Each process unit may also be set so that translation can be performed between three or more languages. Furthermore, each process unit may be constructed so as to translate, into a particular language, input sentences written in a plurality of languages.

Further, in the embodiment, only one mode is selected from some translation modes. However, translations may be performed in parallel using all the translation modes. In this case, users make their choices as to the results of translation, considering the resultant level of translation, required process time, translation accuracy estimation score, etc.

These alternatives may also be employed in the following embodiments.

(Second Embodiment)

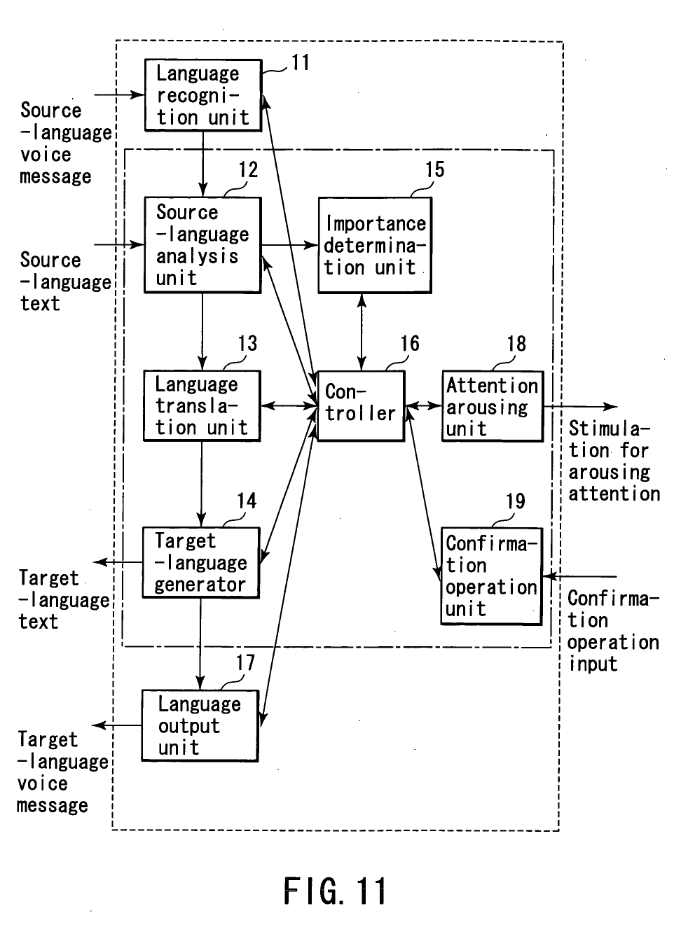

FIG. 11 is a block diagram illustrating a communication support apparatus according to a second embodiment of the invention. In FIG. 11, elements similar to those in FIG. 1 are denoted by corresponding reference numerals, and no detailed description is given thereof.

The communication support apparatus of the embodiment incorporates an attention-arousing unit 18 and confirmation operation unit 19, in addition to the elements shown in FIG. 1. The attention-arousing unit 18 is used to arouse attention in a user under the control of the controller 16. When the importance determination unit 15 detects an input of a high importance, the controller 16 instructs the attention-arousing unit 18 to execute an operation for arousing attention in a user. For example, the attention-arousing unit 18 may be a buzzer device for outputting an alarm, a vibrator that vibrates, a light device that flickers, a display screen that performs inversing or flickering display, or a stimulator that electrically stimulates a user. By virtue of these functions, users are urged to pay attention to the communication support apparatus. Specifically, the attention-arousing unit 18 can be realized by a vibrator, alarm sound, LED (Light Emission Diode) display, LCD (Liquid Crystal Display), etc., which are employed in existing mobile phones, PDAs (Personal Digital Assistants), etc. Further, the attention-arousing operation may be performed utilizing a message spoken or written in the mother tongue of users.

The confirmation operation unit 19 is an element for enabling the controller 16 to determine whether or not a user has confirmed the attention-arousing operation executed by the attention-arousing unit 18. Upon receiving an input indicative of the confirmation operation of a user, the confirmation operation unit 19 informs the controller 16 of this. As described above, when the controller 16 has instructed the attention-arousing unit 18 to perform an operation for arousing attention in a user, the confirmation operation unit 19 informs the controller 16 of whether or not a confirmation operation by the user has occurred. Depending upon whether or not there is a confirmation operation, the controller 16 re-executes or stops arousing of attention in a user, or adjusts the level of the attention-arousing operation. The confirmation operation unit 19 includes, for example, a switch and sensors, such as a touch sensor, voice sensor, vibration sensor, camera, etc.

FIG. 12 is a flowchart useful in explaining the process performed by the communication support apparatus of FIG. 11. The flowchart of FIG. 12 is obtained by adding a new step between the steps S7 and S8 in FIG. 5. Each step of the flowchart is executed by a corresponding unit of FIG. 11 when the controller 16 outputs an instruction to the unit.

After the language translation unit 13 is set in the high-load and high-accuracy mode, the controller 16 instructs the attention-arousing unit 18 to start an attention-arousing operation. Upon receiving the instruction from the controller 16, the attention-arousing unit 18 starts to arouse attention in a user as described above, utilizing sound or vibration (step S71). Subsequently, the controller 16 receives, from the confirmation operation unit 19, a signal indicating whether or not the user has performed an operation for confirming the detection of the attention-arousing operation, thereby determining, from the signal, whether or not the user has performed a confirmation operation (step S72). If it is determined that the user has performed a confirmation operation, the program proceeds to a step S74, while if it is determined that the user has not yet performed a confirmation operation, the program proceeds to a step S73.

At the step S73, the communication support apparatus strengthens the attention-arousing operation to make the user recognize the attention-arousing operation. For example, the volume of the alarm, the magnitude of the vibration, or the intensity of the flickering light, output from the attention-arousing unit 18, is increased. At the step S74, considering that the user has noticed the attention-arousing operation, the operation of the attention-arousing unit 18 is stopped.

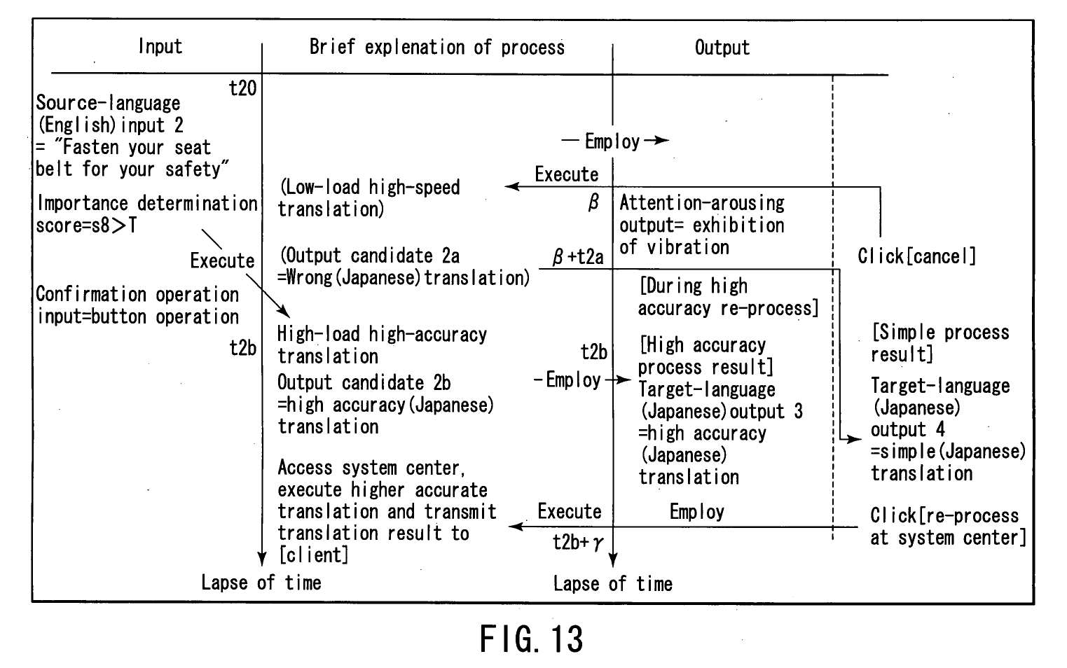

FIG. 13 illustrates examples of results obtained by the process shown in FIG. 12. In FIG. 13, it is assumed that a person whose mother tongue is Japanese travels in an English-speaking country, and is in an airplane with the communication support apparatus of FIG. 11 contained in a pocket.

In the airplane, when a voice message “Fasten your seat belt for your safety” (source-language (English) input 2) is announced at a time point t20, the communication support apparatus of this embodiment automatically detects the voice message and performs voice recognition, source-language analysis and importance determination on the message. Since the source-language (English) input 2 contains an important keyword “safety”, which is stored in the important keyword storage 152 at a storage address of p8 as shown in FIG. 3, the value s8 in the entry score area with the storage address of p8 is obtained as an importance determination score. Assume that the importance determination score of s8 is higher than the predetermined threshold value T. In this case, the source-language (English) input 2 is determined to be an input of a high importance, therefore a translation is performed in the high-load high-accuracy mode. At this time, the display panel, for example, displays a message “High-accuracy translation is now being performed”, with the result that the user can recognize that a translation is now being performed in the high-load high-accuracy mode.

When the high-load high-accuracy mode is set, the controller 16 instructs the attention-arousing unit 18 to start its operation. According to this instruction, the attention-arousing unit 18 imparts, for example, vibration-stimulation to the user. It is expected that this stimulation prevents the user from missing important information that is spoken in a foreign language, even if they do not pay attention to it. This is because the communication support apparatus automatically detects important information and informs the user of it utilizing the above-mentioned stimulation. Since an announcement may be often performed abruptly, it is very useful to arouse attention in a user as described above.

When the user notices the vibration-stimulation, they take the communication support apparatus out of their pocket, and operate, for example, a button to input a signal indicating that they have noticed the attention-arousing operation. As a result, the vibration for arousing attention is stopped. Thereafter, the translation started at a time point t2b in the high-load high-accuracy mode is finished, thereby displaying, for the user, a target-language (e.g. Japanese) output 3 corresponding to the source-language (English) input 2 “Fasten your seat belt for your safety”, as a “high-accuracy translation result” (appropriate high-quality translation result).

As an optional matter, the user can click a “cancel” button if they want to change the translation mode to the low-load high-sped mode because, for example, they want to quickly obtain a translation result. In the case of FIG. 13, the user clicks the “cancel” button at a time point β. When the “cancel” button is clicked, the translation mode is changed form the high-load high-accuracy mode to the low-load high-sped mode, thereby starting a translation in the low-load high-sped mode. At a time point (β+t2a), a target-language (e.g. Japanese) output 4 meaning, for example, “Connect your safety and belt” is obtained as a “simple processing result”. This translation is incorrect. Further, a button may be provided which designates a translation in the high-load high-accuracy mode. For example, if an output Japanese sentence is awkward and seems to be an incorrect translation, it is expected, from the click of the high-load high-accuracy mode button, that an appropriate translation can be obtained.

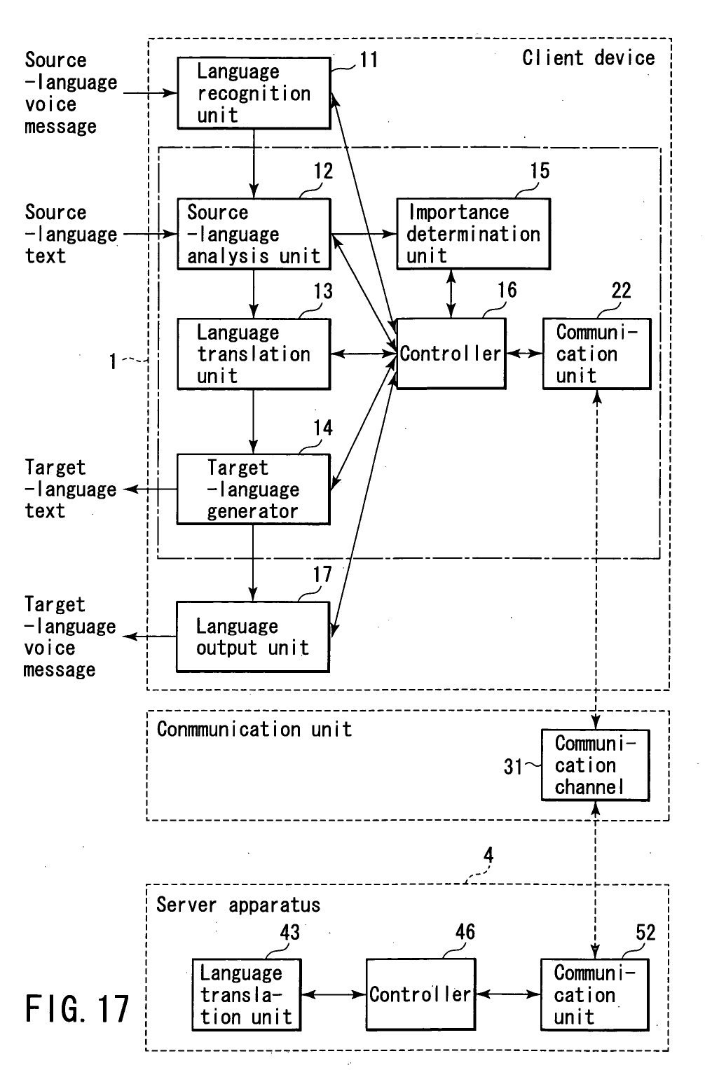

As another optional matter, the communication support apparatus may be connected to an external server apparatus, described later with reference to FIG. 17 et seq., thereby making the server apparatus execute a high accuracy translation.

It is expected from the communication support apparatus of the second embodiment that a high-accuracy translation is automatically selected for an input containing important contents, and attention to the support apparatus is aroused in a user so as not to miss the important contents.

(Third Embodiment)

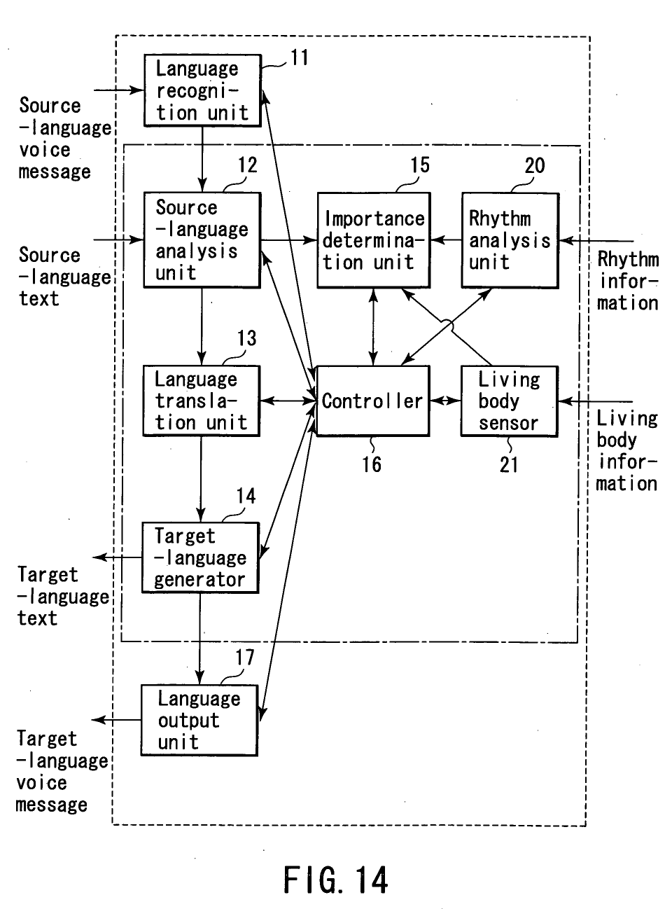

FIG. 14 is a block diagram illustrating a communication support apparatus according to a third embodiment of the invention. In FIG. 14, elements similar to those in FIG. 1 are denoted by corresponding reference numerals, and no detailed description is given thereof.

The communication support apparatus of the third embodiment incorporates a rhythm analysis unit 20 and living body sensor 21 in addition to the elements shown in FIG. 1. The rhythm analysis unit 20 analyzes voice data input to the communication support apparatus under the control of the controller 16. The rhythm analysis unit 20 detects the value of or a change in at least one of the rhythmic factors, such as intonation, pitch, power, pause position, pause length, accent position, utterance continued time, utterance interval and utterance speed. When the analysis unit 20 detects a remarkable change in rhythm, it supplies the importance determination unit 15 with the remarkable change as prominent information, together with information concerning the time point of the detection. If it is detected from the prominent information that the input utterance contains an emphasized or tense sound, the importance determination unit 15 determines that the input utterance data is of a high importance.

The living body sensor 21 detects information concerning the body of a user who utilizes the communication support apparatus of the embodiment. The living body information comprises parameters, such as breathing speed, breathing depth, pulse speed, blood pressure, blood sugar level, body temperature, skin potential, perspiration amount, etc. When the sensor 21 monitors the values of these parameters or changes in the parameter values, and detects remarkable changes therein, it supplies the importance determination unit 15 with the remarkable changes as biometrics information, together with information concerning the time points of occurrences of the changes. The importance determination unit 15 determines that a source-language input at a time point, at which the user is estimated to be tense from the biometrics information, is of a high importance.

The living body sensor 21 operates when a user of the communication support apparatus, whose mother tongue is the second language, tries to communicate with a person whose mother tongue is the first language. In this embodiment, the living body sensor 21 operates when a user of the communication support apparatus, whose mother tongue is Japanese, tries to communicate with a person whose mother tongue is English. On the other hand, the rhythm analysis unit 20 operates regardless of whether a translation is performed from the first language to the second language or vice versa, which differs from the living body sensor 21. In other words, the rhythm analysis unit 20 operates both when a user of the communication support apparatus, whose mother tongue is the second language, tries to communicate with a person whose mother tongue is the first language, and vice versa.

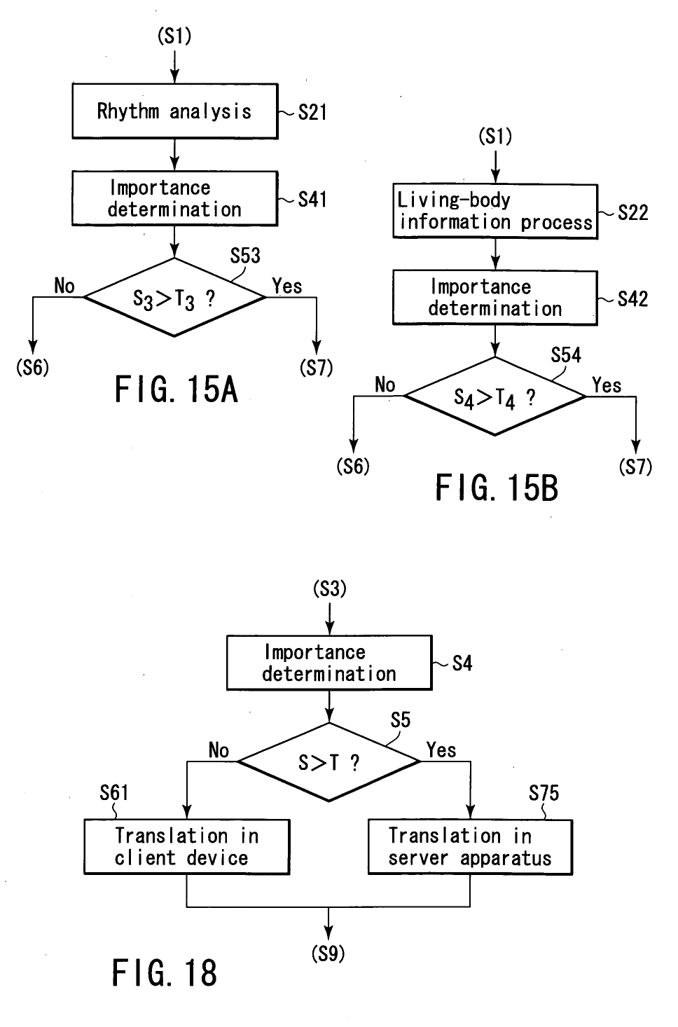

FIG. 15A is a flowchart useful in explaining the process performed by the rhythm analysis unit 20 appearing in FIG. 14. The process illustrated in FIG. 15A is obtained by replacing the steps S2 to 5S of FIG. 5 with new ones. Each step of the process is executed by a corresponding unit of FIG. 14 when the controller 16 outputs an instruction to the unit.

If it is determined at the step S1 that there is a source-language input, the source-language input is supplied to the rhythm analysis unit 20 (step S21). As mentioned above, the rhythm analysis unit 20 detects the value of or a change in at least one of the rhythmic factors, such as intonation, pitch, power, pause position, pause length, accent position, utterance continued time, utterance interval and utterance speed. In this embodiment, the utterance speed is used as a rhythmic factor value (importance determination score) S₃, and the rhythm analysis unit 20 detects the voice data of the input language and measures the utterance speed S₃ (step S21).

Subsequently, a predetermined threshold value T₃ corresponding to the utterance speed S₃ measured by the importance determination unit 15 at the step S21 is extracted from a memory (step S41). It is determined whether or not the utterance speed S₃ measured at the step S21 is higher than the predetermined threshold value T₃ extracted at the step S41 (step S53). If it is determined that the utterance speed S₃ is higher than the predetermined threshold value T₃, the program proceeds to the step S7, whereas if the utterance speed S3 is not higher than the predetermined threshold value T₃, the program proceeds to the step S6. The predetermined threshold value T₃ is pre-adjusted so that the importance determination score S3 appropriately corresponds to a to-be-set translation mode.

FIG. 15B is a flowchart useful in explaining the process performed by the living body sensor 21 appearing in FIG. 14. The process illustrated in FIG. 15B is obtained by replacing the steps S2 to S5 of FIG. 5 with new ones. Each step of the process is executed by a corresponding unit of FIG. 14 when the controller 16 outputs an instruction to the unit.

If it is determined at the step S1 that there is a source-language input from a user of the communication support apparatus, the living body sensor 21 monitors the body of the user, thereby detecting one of the living body parameters or a change in the one parameter, the parameters being, for example, breathing speed, breathing depth, pulse speed, blood pressure, blood sugar level, body temperature, skin potential, perspiration amount, etc. In this embodiment, the pulse speed is used as a living body parameter S₄, and the living body sensor 21 measures the pulse speed S₄ of the user when there is a source-language input (step S22). Thus, the living body information of a user whose mother tongue is the second language is obtained when the user tries to communicate with a person whose mother tongue is the first language. The communication support apparatus is set, for example, such that when a user makes a source-language input in the form of, for example, their voice message, if they push a certain button, it is detected that the source-language input is made by them. Thus, it is determined whether the source-language input at the step S1 is made by a user of the apparatus to communicate with another person, or by another person to communicate with the user.

Thereafter, a predetermined threshold value T₄ corresponding to the pulse speed S₄ measured by the importance determination unit 15 at the step S22 is extracted from a memory (step S42). It is determined whether or not the pulse speed S₄ measured at the step S22 is higher than the predetermined threshold value T₄ extracted at the step S42 (step S54). If it is determined that the pulse speed S₄ is higher than the predetermined threshold value T₄, the program proceeds to the step S7, whereas if the pulse speed S₄ is not higher than the predetermined threshold value T₄, the program proceeds to the step S6. The predetermined threshold value T₄ is pre-adjusted so that the importance determination score S₄ appropriately corresponds to a to-be-set translation mode.

As described above with reference to FIGS. 15A and 15B, importance determination may be performed utilizing only rhythm analysis or living body information. Alternatively, importance determination may be performed utilizing both of them. Furthermore, final importance determination may be performed, also referring to the important and similar keywords illustrated in FIGS. 5, 9 and 10. Specifically, for example, the communication support apparatus is set such that unless the threshold value is exceeded in any two of the three cases—importance determination based on important keyword information, rhythm analysis or living body information, the translation mode is not set to the high-load high-accuracy mode. The importance determination on a source-language input utilizing a plurality of determination information items can provide more reliable determination results.

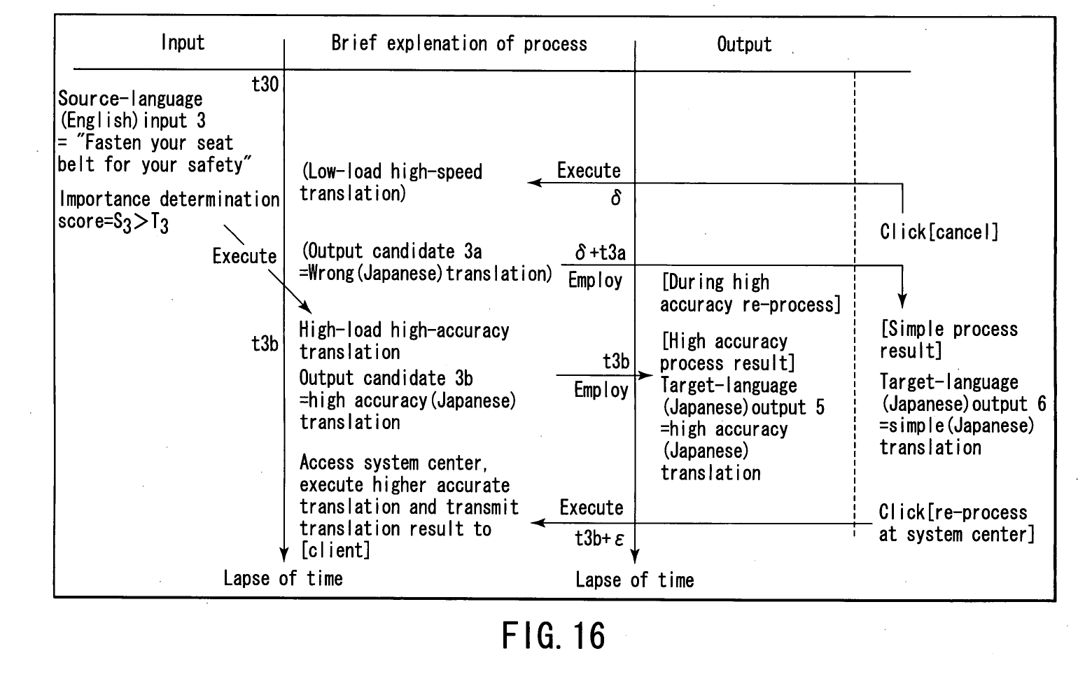

FIG. 16 illustrates examples of results obtained by the processes shown in FIGS. 15A and 15B. In the case of FIG. 16, it is assumed that a person whose mother tongue is Japanese travels in an English-speaking country, and is in an airplane with the communication support apparatus of FIG. 14.

In the airplane, when a voice message “Fasten your seat belt for your safety” (source-language (English) input 3) is announced at a time point t30, the communication support apparatus of this embodiment automatically detects the voice message and performs rhythm analysis and importance determination on the message. At this time, the importance determination on the source-language input may be performed, based on importance determination utilizing important keyword information, as well as the rhythm analysis.

Assume that the importance determination score obtained by the rhythm analysis exceeds the threshold value T₃. The importance determination score based on living body information is not used in this case, because it is used only when a user of the communication support apparatus tries to communicate with another person. In this case, it is determined that the source-language (English) input 3 is of a high importance, and a translation is performed in the high-load high-accuracy mode. At this time, a message “High-accuracy translation is now being performed” is displayed on, for example, a display panel, with the result that the user can recognize that a translation is now being performed in the high-load high-accuracy mode. The next et seq. operations are similar to those explained with reference to FIG. 13.

(Fourth Embodiment)

FIG. 17 is a block diagram illustrating a communication support apparatus according to a fourth embodiment, and a server apparatus. In FIG. 17, elements similar to those in FIG. 1 are denoted by corresponding reference numerals, and no detailed description is given thereof.

The communication support apparatus of the fourth embodiment incorporates a communication unit 22 in addition to the elements shown in FIG. 1. The communication support apparatus of this embodiment can serve as a client device 1. The communication unit 22 transmits and receives information to and from an external server apparatus 4 via a communication channel 31. The communication unit 22 transmits a source-language input to the server apparatus 4 if the controller 16 determines that a translation of higher accuracy is needed than that obtained by the language translation unit 13 in the high-load high-accuracy mode. The communication unit 22 receives a translation of the source-language input made by the server apparatus 4, and outputs it to the controller 16. The communication unit 22 is a network communication means realized by, for example, a wireless or wired LAN (Local Area Network), and enables the client device 1 to utilize, from a remote place, the services provided by the server apparatus, when the client device 1 issues a request for them.

The server apparatus 4 comprises a language translation unit 43, controller 46 and communication unit 52. The language translation unit 43 differs from the language translation unit 13 of the client device 1 only in that the former 43 has a higher translation capacity than the latter 13. In other words, the language translation unit 43 can provide a more accurate translation than that obtained by the language translation unit 13 in the high-load high-accuracy mode. The controller 46 receives, from the communication unit 52, an internal expression corresponding to a source-language (first language) input, and instructs the language translation unit 43 to translate it. The communication unit 52 receives, from the client apparatus 1, an internal expression corresponding to a source-language (first language) input, and transmits a translation of the language translation unit 43 to the client apparatus 1.

More specifically, the language translation unit 43 performs a translation from the first language to the second language. To this end, the language translation unit 43 receives an internal expression corresponding to a source-language (first language) input, via the communication channel 31, like the language translation unit 13. The language translation unit 43 performs conversion of words from the first language to the second language, or conversion of a syntactic structure of the first language into a syntactic structure of the second language. More specifically, the language translation unit 43 converts a first-language internal expression corresponding to a source-language (first language) input, into a second-language internal expression in the form of a syntax analysis tree or meaning network, corresponding to the source-language (first language) input. The language translation unit 13 incorporated in the client device 1 has its translation accuracy and/or speed limited by its constraints in structure and/or throughput due to its small size and light weight. On the other hand, the language translation 43 has almost no constraints in throughput, processing speed, memory capacity, the number of analysis rules, the number of candidates for analysis, etc., therefore can perform more accurate translations.

In response to a request to translate the first-language internal expression received from the client device 1 via the communication channel 31 and communication unit 52, the controller 46 controls the language translation unit 43 to perform a translation from the first language to the second language. After that, the controller 46 obtains a second-language internal expression output from the language translation unit 43 as a translation result, and outputs it to the communication unit 52.

The communication unit 52 is a network communication means realized by, for example, a wireless or wired LAN (Local Area Network), and enables the client device 1 to utilize the services provided by the server apparatus 4, when the client device 1 issues a request for them.

The above-described client device 1 and server apparatus 4 provide a communication support system of a minimum scale. This communication support system enables users of the light and small client device 1 to carry the device 1 with them and perform network communication with the server apparatus 4 installed in, for example, a service center via a communication channel, such as a wired and/or wireless network, thereby enabling the device 1 to obtain services therefrom.

Further, the communication channel 31 includes, for example, transmission waves as a medium for realizing communications between radio communication apparatuses, a space as the path of the transmission waves, electric and optical cables as mediums for realizing wired communications, and relay, distribution, exchange and connection devices such as a router, repeater, radio access point, etc. The communication channel 31 enables remote network communications between the client device 1 and server apparatus 4 via the communication unit 22 of the client device 1 and the communication unit 52 of the server apparatus 4 described later.

The input determined to be highly important by the client device is translated in a high quality translation mode by the server apparatus, utilizing remote network communication via a network and communication channel. On the other hand, the input determined not to be so highly important is translated by the client device as conventionally.

FIG. 18 is a flowchart useful in explaining the process performed by the communication support system including the communication support apparatus (client device 1) of FIG. 17. The steps S1 to S4 and the steps S9 et seq. are similar to those illustrated in FIG. 5. Each step of the flowchart of FIG. 18 is performed when the controller 16 outputs an instruction to a corresponding unit in FIG. 1.

The client device 1 is limited in size and weight so that, for example, it can be easily carried. On the other hand, the server apparatus 4 has no such limits, since it is not required to, for example, be carried easily. Accordingly, the server apparatus 4 can be designed to have a much larger throughput and memory capacity, much higher processing speed, and a much larger number of analysis rules and candidates than the client device 1. Theoretically, the server apparatus 4 can provide machine translations of the highest accuracy presently possible. The communication support system requests the server apparatus 4 to translate a source-language input determined to be important.

It is determined whether or not the importance determination score computed by the controller 16 at the step S4 is higher than a predetermined threshold value T (step S5). If it is determined that the importance determination score is higher than the predetermined threshold value T, the program proceeds to a step S75, whereas if the importance determination score is not higher than the predetermined threshold value T, the program proceeds to a step S61.

At the step S75, the server apparatus 4 is requested to translate a first-language internal expression. Specifically, the source-language analysis unit 12 of the client device 1 outputs a first-language internal expression to the communication unit 22 of the device 1, which, in turn, transmits it to the server apparatus 4. The communication unit 52 of the server apparatus 4 receives the first-language internal expression, and outputs it to the language translation unit 43 under the control of the controller 46. The controller 46 instructs the language translation unit 43 to translate the first-language internal expression into a second-language internal expression. The language translation unit 43 executes the translation.

The step S61 is obtained by combining the step S6 or S7 with the step S8 in FIG. 5. Specifically, in the client device 1, a first-language internal expression is translated into a second-language internal expression. The translation mode employed in the language translation unit 13 may be preset in either the high-load high-accuracy mode or low-load high-speed mode, or may be selected from the two modes by a user.

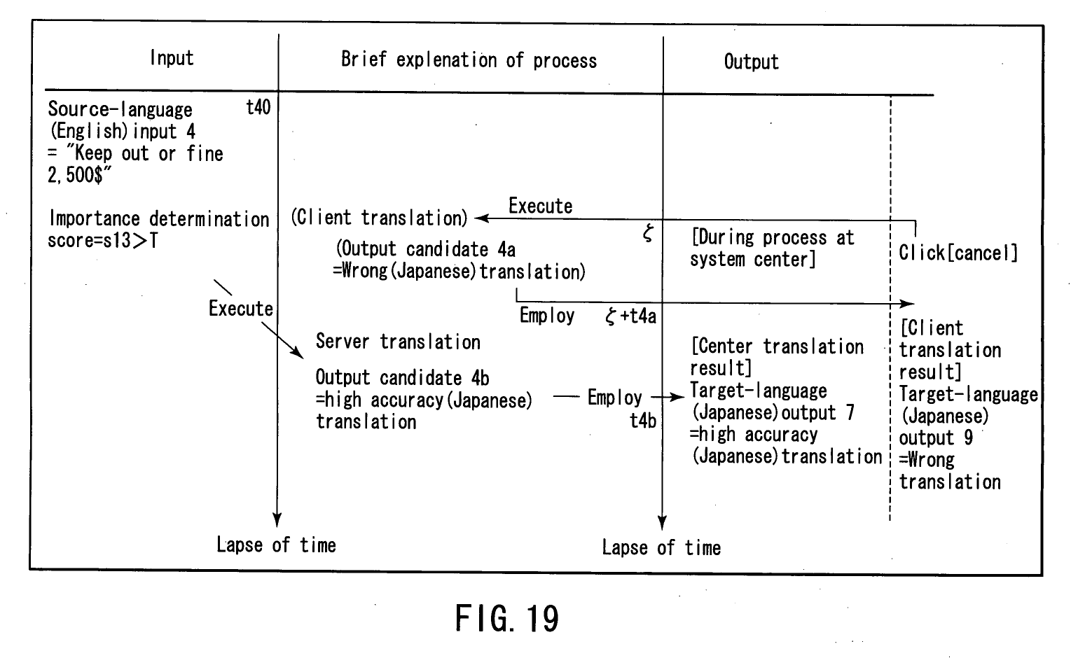

FIG. 19 illustrates examples of results obtained by the process shown in FIG. 18. In the case of FIG. 19, it is assumed that a person whose mother tongue is Japanese travels in an English-speaking country, carrying the client device 1 that can utilize, via a network, the translation service provided by the server apparatus 4 installed in a service center.

Assume that at a time point t40, the client device 1 detects a voice message “Keep out or fine 2,500$” (source-language (English) input 4). The client device 1 performs voice recognition, language analysis and importance determination on the message. Since an internal expression based on the source-language (English) input 4 contains an important keyword “fine” that is stored in the important keyword storage 152 at a storage address p13, a value of s13 in the entry score area with the storage address p13 is obtained as an importance determination score. Assume here that the importance determination score s13 exceeds the predetermined threshold value T. In this case, the source-language (English) input 4 is determined to be highly important, and sent to the server apparatus 4, where it is translated by the language translation unit 43 for performing a more accurate translation than that of the client device 1. At this time, a message “During process at system center” (Now being processed in a center) is displayed on, for example, the display panel of the device 1, thereby enabling a user to know that the server apparatus 4 is performing a translation.

The server apparatus 4 receives the source-language (English) input 4 and translates it into a high-quality target-language (Japanese) output 7 that appropriately corresponds to the message “Keep out or fine 2,500$”. The thus-obtained translation result (output 7) is transmitted to the client device 1 via the network, and provided at a time point t4b to the user as a “Center translation result” via the target-language generator 14 and language output unit 17.

As an optional matter, the user can shift the processing from the server apparatus 4 to the client device 1 if they want to, for example, obtain a translation result quickly. To this end, it is sufficient if the user clicks a “cancel” button while the message “During process at system center” (Now being processed in a center) is displayed. In the example of FIG. 19, the user clicks the “cancel” button at a time point ζ. When the “cancel” button is clicked, the server apparatus 4 stops the translation operation, and the client device 1 starts a translation operation. At a time point (ζ+t4a), the client device 1 outputs, as a “Client translation result”, a target-language (Japanese) output 8, for example, that does not exactly correspond to the English message “Keep out or fine 2,500$”, i.e., an incorrect translation. Further, a button for instructing the-server apparatus 4 to perform a translation may be provided on the client device 1. If, for example, the user feels the output Japanese sentence awkward and cannot trust it, they can expect a more appropriate translation result by clicking the button for instructing the server apparatus 4 to perform a translation.

In the communication support system of this embodiment, an input containing important contents is automatically translated by the server apparatus 4 that can provide a higher accuracy translation than the client device 1, whereby users can appropriately catch important information spoken in a non-mother tongue.

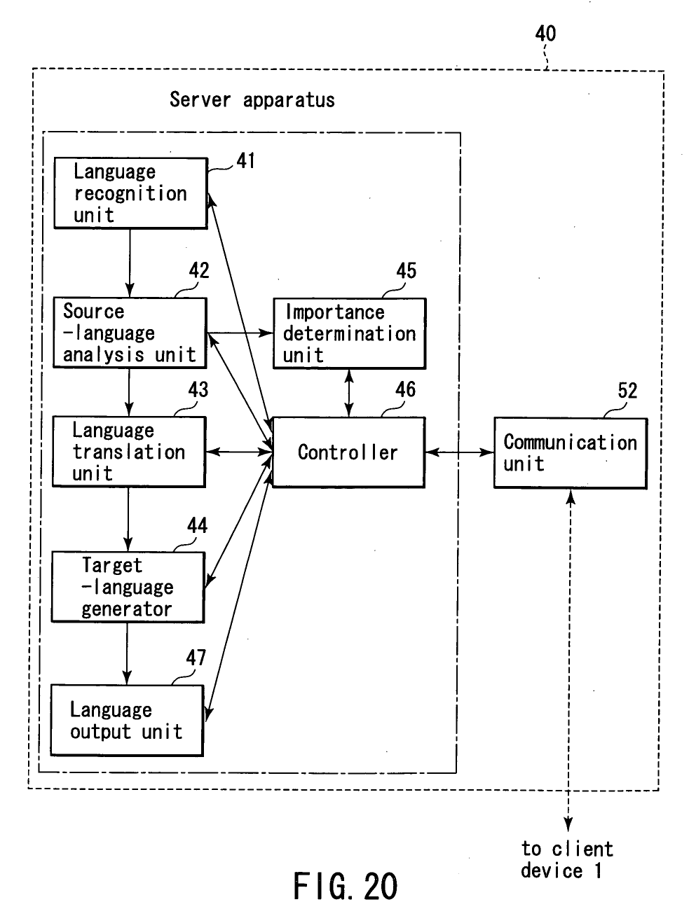

FIG. 20 is a block diagram illustrating a modification of the server apparatus appearing in FIG. 17.

The server apparatus 40 shown in FIG. 20 comprises elements similar to those of the client device 1 in FIG. 17. Each element of the server apparatus 40 has a function similar to that of a corresponding element of the client device 1, but shows a much higher performance than it.

The client device 1 receives a voice wave signal and transmits it to the server apparatus 40. In the server apparatus 40 having receives the voice wave signal, a language recognition unit 41 performs a high accuracy language recognition. Thereafter, source-language analysis, importance determination, language translation, target-language generation and language output are performed in the server apparatus 40. The resultant language output is supplied from the server apparatus 40 to the client device 1. On the other hand, the client device 1 only has to receive a voice wave signal as a source (first) language input, transmit it to the server apparatus 40, receive a voice wave signal indicative of a second-language translation of the first language input, and display the translation to users.

As described above, the server apparatus 40 may perform only part of all processes from the reception of a voice wave signal indicative of a source-language input to the output of a voice wave signal indicative of a translation result. For example, as shown in the example of FIG. 17, the server apparatus 40 may perform only a translation process. The server apparatus 40 may perform only another process included in the processes. For example, the server apparatus 40 may be modified such that only the language output unit 47 is operated to thereby perform a voice synthesis of a second-language translation result with high accuracy, thereby returning the synthesis result to the client device 1. Further, the server apparatus 40 may be modified such that it performs a combination of some of its processes. For example, the server apparatus 40 may receive, from the client device 1, a voice wave signal indicative of a source-language input, perform morpheme analysis, syntax analysis, meaning analysis, etc., using the source-language analysis unit 42, generate a first-language internal expression corresponding to the source-language input, translate the first-language internal expression into a second-language internal expression, using the language translation unit 43, and return the translation result to the client device 1.

If the server apparatus 40 performs only part of the processes of the communication support system, it may be constructed to have only an element for performing the only part. For example, if the server apparatus 40 receives a source-language surface character string, generates a first-language internal expression from the surface character string, and performs a translation from the first-language internal expression to a second-language internal expression, it is sufficient if the server apparatus 40 incorporates only the source-language analysis unit 42, language translation unit 43, controller 46 and communication unit 52 shown in FIG. 20.

As another example, a plurality of server apparatuses may be prepared, and each server apparatus is made to have its characteristic function. For example, the server apparatuses are set to process respective languages, and the client device 1 is selectively connected to the server apparatuses in accordance with the language to be translated.

Similarly, a plurality of client devices 1 may be prepared. In this case, it is preferable that the load be distributed to a plurality of server apparatuses so that the load will not concentrate on a certain server apparatus.

Although in the above-described communication support system, different processes are executed between the client device 1 and server apparatus 40, the client-device 1 and server apparatus 40 may perform the same process in a parallel manner. In this case, users compare the translation results of both apparatuses and select one of them. Users may make their choices as to the translation results, considering the resultant level of translation, required process time, translation accuracy estimation score, etc.

Further, in the above-described communication support system, it is assumed that the client device 1 always receives a translation result from the server apparatus 40. However, if the client device 1 cannot use the network, cannot obtain a translation result from the server apparatus 40 within a preset time period, or cannot receive a translation result from the server apparatus 40 for some reason, the client device 1 displays its own translation result to users. These can solve the problems that may occur in the server/client communication support system, communications between which are not always assured.

The communication support apparatus according to each of the above-described embodiments may be set such that a series of input source-language information items regarded as important, and/or the history of the processing results of the information items is stored in a memory, and is displayed on the display of the apparatus when users perform a predetermined operation.

Further, recognition information indicative of a predetermined importance level may be attached, such as a tag, to source-language information of a high importance when this information is transmitted. In this case, the communication support apparatus may determine the importance level of the source-language information from the recognition information attached thereto, and determines, for example, the translation mode based on the importance level. For example, important information, such as an earthquake alarm, is always generated together with recognition information indicative of a high importance. As another example, in an international airport in which people who speak different languages gather, an announcement regarded as important for travelers is made together with recognition information indicative of a high importance. Furthermore, information indicating the place of dispatch of source-language information may be attached thereto together with recognition information.

In addition, the communication support apparatus may be set to automatically subject, to audio or character recording, a source-language input with recognition information indicative of a high importance, or a source-language input determined important by the communication support apparatus. The communication support apparatus may also be set to generate, to users, a voice message corresponding to the recorded source-language input.

As described above, the communication support apparatus of each embodiment can urge users to appropriately behave when they receive a message of a non-mother tongue.

Since the communication support apparatus of each embodiment is connectable, via a network, to a server apparatus that can perform very much accurate processing, it can simultaneously realize high performance, downsizing, weight saving, cost down and lower power consumption. The communication support apparatus acquires a more accurate translation from the server apparatus when connected thereto.

Further, since the communication support apparatus itself can perform a translation corresponding the importance level of a source-language input, the time required to translate a source-language input can be reduced.

Even if networks cannot be used, the communication support apparatus of each embodiment can output a translation of a source-language input. In other words, the communication support apparatus can output translations regardless of the communication state of networks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication support apparatus comprising:
an acquisition unit configured to acquire source-language information represented in a first language;
a first determination unit configured to determine a level of importance of the source-language information;
a setting unit configured to set, based on the level of importance, an accuracy of translation with which the source-language information is translated into corresponding language information represented in a second language; and
a translation unit configured to translate the source-language information into the corresponding language information with the accuracy.

2. The communication support apparatus according to claim 1, wherein the setting unit sets the accuracy of translation based on a level of emergency as the level of importance.

3. The communication support apparatus according to claim 2, further comprising:
a providing unit configured to provide stimulation to a user if the level of importance is higher than a threshold value;
a stimulation determination unit configured to determine whether or not the user confirms the stimulation;
an interruption unit configured to interrupt providing of the stimulation if the stimulation determination unit determines that the user confirms the stimulation; and
an increasing unit configured to increase the stimulation if the stimulation determination unit determines that the user fails to confirm the stimulation.

4. The communication support apparatus according to claim 3, wherein the providing unit is configured to provide, as the stimulation, at least one of light stimulation, sound stimulation, physical stimulation caused by a physical movement, and electrical stimulation.

5. A communication support apparatus comprising:
an acquisition unit configured to acquire source-language information represented in a first language;
a first determination unit configured to determine a level of importance of the source-language information;
a translation unit configured to translate the source-language information into corresponding language information represented in a second language;
an exhibit unit configured to exhibit the corresponding language information;
a setting unit configured to set, based on the level of importance, a process accuracy with which at least one of an acquisition process to be carried out by the acquisition unit, a translation process to be carried out by the translation unit, and an exhibit process to be carried out by the exhibit unit is performed; and
an execution unit configured to execute at least one of the acquisition process, the translation process and the exhibit process with the process accuracy.

6. The communication support apparatus according to claim 5, wherein the first determination unit comprises:
a first storage which stores important keywords of the first language; and
a comparison unit configured to compare the source-language information with the important keywords.

7. The communication support apparatus according to claim 6, wherein:
the first storage further stores a score corresponding to each important keyword; and
the comparison unit extracts each compared important keyword and the score corresponding to each compared important keyword, and determines the level of importance based on the score.

8. The communication support apparatus according to claim 5, wherein:
the setting unit sets, for the translation process, a high accuracy mode in which a high accuracy translation is performed, if the level of importance is higher than a threshold value, and a high speed mode in which a high speed translation is performed, if the level of importance is not higher than the threshold value.

9. The communication support apparatus according to claim 8, wherein the setting unit changes, in accordance with a set one of the high accuracy mode and the high speed mode, at least one of the number of candidates of expressions of the second language used to determine which one of the expressions corresponds to an expression contained in the source-language information, a range in a dictionary used for translating the source-language information into the corresponding language information, an available memory capacity, a process time required for the translation process, a process speed at which the translation process is performed.

10. The communication support apparatus according to claim 7, wherein the comparison unit determines the level of importance based on a sum of scores corresponding to the important keywords contained in the source-language information.

11. The communication support apparatus according to claim 6, wherein:
the first determination unit further comprises a second storage which stores similar keywords similar to the important keywords of the first language; and
the comparison unit compares the source-language information with the similar keywords.

12. The communication support apparatus according to claim 11, wherein:
the second storage further stores similarities corresponding to the similar keywords; and
the comparison unit extracts compared similar keywords and the similarities corresponding to the compared similar keywords, and determines the level of importance based on the similarities.

13. The communication support apparatus according to claim 12, wherein the setting unit sets a high accuracy mode for a high accuracy translation, if at least one of each score and each similarity is higher than a threshold value.

14. The communication support apparatus according to claim 5, further comprising:
a providing unit configured to provide stimulation to a user if the level of importance is higher than a threshold value;
a stimulation determination unit configured to determine whether or not the user confirms the stimulation;
an interruption unit configured to interrupt providing of the stimulation if the stimulation determination unit determines that the user confirms the stimulation; and
an increasing unit configured to increase the stimulation if the stimulation determination unit determines that the user fails to confirm the stimulation.

15. The communication support apparatus according to claim 14, wherein the providing unit is configured to provide, as the stimulation, at least one of light stimulation, sound stimulation, physical stimulation caused by a physical movement, and electrical stimulation.

16. The communication support apparatus according to claim 5, further comprising a rhythm analysis unit configured to analyze a rhythm of acquired source-language information, and wherein the first determination unit determines the level of importance based on the rhythm.

17. The communication support apparatus according to claim 16, wherein the first determination unit comprises a detection unit configured to detect a level of tension of a user, and a second determination unit which determines the level of importance based on the level of tension.

18. The communication support apparatus according to claim 16, wherein the rhythm analysis unit analyzes the rhythm which includes at least one of an intonation, a pitch, power, a pause position, a pause length, an accent position, an utterance-continued period, an utterance interval and an utterance speed.

19. The communication support apparatus according to claim 5, further comprising a living body analysis unit configured to analyze living body information of a user if the source-language information is acquired, and the first determination unit determines the level of importance based on the living body information.

20. The communication support apparatus according to claim 19, wherein the first determination unit comprises a detection unit configured to detect a level of tension of a user based on the living body information, and a second determination unit configured to determine the level of importance based on the level of tension.

21. The communication support apparatus according to claim 19, wherein the living body information includes at least one of a breathing speed, a breathing depth, a pulse speed, a blood pressure, a blood sugar level, a body temperature, a skin potential, and a perspiration amount.

22. The communication support apparatus according to claim 5, further comprising a communication unit configured to enable the apparatus to communicate with a translation device which translates the source-language information into the corresponding language information, and wherein if the level of importance is determined to be higher than a threshold value, the communication unit is connected to the translation device to transmit the source-language information to the translation device and receive a translation result from the translation device.

23. The communication support apparatus according to claim 5, wherein the acquisition unit acquires the source-language information in a form of voice information, and includes a conversion unit configured to convert the voice information into text information.

24. The communication support apparatus according to claim 5, wherein the exhibit unit includes a conversion unit configured to convert the corresponding language information into voice information.

25. The communication support apparatus according to claim 5, further comprising:
a first storage which stores the source-language information;
a first reproduction unit configured to reproduce the source-language information;
a second storage which stores the corresponding language information;
a second reproduction unit configured to reproduce the corresponding language information;
an operation start unit configured to start an operation of at least one of the first storage, the first reproduction unit, the second storage and the second reproduction unit, if the level of importance is higher than a threshold value.

26. The communication support apparatus according to claim 5, wherein the setting unit sets the accuracy of translation based on a level of emergency as the level of importance.

27. A communication support method comprising:
acquiring source-language information represented in a first language;
determining a level of importance of the source-language information;
translating the source-language information into corresponding language information represented in a second language;
exhibiting the corresponding language information;
setting, based on the level of importance, a process accuracy with which at least one of an acquisition process for acquiring the source-language information, a translation process for translating the source-language information into the corresponding language information, and an exhibit process for exhibiting the corresponding language information is performed; and
executing at least one of the acquisition process, the translation process and the exhibit process with the process accuracy.

28. The communication support method according to claim 27, wherein setting the process accuracy includes setting, for the translation process, a high accuracy mode in which a high accuracy translation is performed, if the level of importance is higher than a threshold value, and a high speed mode in which a high speed translation is performed, if the level of importance is not higher than the certain threshold value.

29. The communication support method according to claim 27, further comprising communicating with a translation device which translates the source-language information into the corresponding language information, and wherein if the level of importance is determined to be higher than a threshold value, transmitting the source-language information to the translation device and receiving a translation result from the translation device.

30. A communication support program stored in a computer readable medium, comprising:
means for instructing a computer to acquire source-language information represented in a first language;
means for instructing the computer to determine a level of importance of the source-language information;
means for instructing the computer to translate the source-language information into corresponding language information represented in a second language;
means for instructing the computer to exhibit the corresponding language information;
means for instructing the computer to set, based on the level of importance, a process accuracy with which at least one of an acquisition process to be carried out by the means for instructing the computer to determine the level, a translation process to be carried out by the means for instructing the computer to translate the source-language information, and an exhibit process to be carried out by the means for instructing the computer to exhibit the corresponding language information is performed; and
means for instructing the computer to execute at least one of the acquisition process, the translation process and the exhibit process with the process accuracy.

31. The communication support program according to claim 30, wherein the means for instructing the computer to set the process accuracy instructs the computer to set, for the translation process, a high accuracy mode in which a high accuracy translation is performed, if the level of importance is higher than a threshold value, and a high speed mode in which a high speed translation is performed, if the level of importance is not higher than the threshold value.

32. The communication support program according to claim 30, further comprising means for instructing the computer to communicate with a translation device which translates the source-language information into the corresponding language information, and wherein if the level of importance is determined to be higher than a threshold value, the means for instructing the computer to communicate with the translation device is connected to the translation device to transmit the source-language information to the translation device and receive a translation result from the translation device.
